(19) United States
(12) Patent Application Publication
(10) Pub. No.: US 2011/0120967 A1
(43) Pub. Date: May 26, 2011

(54) CONVEYOR DEVICE AND METHOD FOR MOVING A WEIGHT USING THE CONVEYOR DEVICE

(75) Inventor: YAN-JUN ZUO, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Taipei Hsien (TW)

(21) Appl. No.: 12/795,811

(22) Filed: Jun. 8, 2010

(30) Foreign Application Priority Data
Nov. 20, 2009 (CN) 200910310162.4

(51) Int. Cl. B66C 23/20; B66C 11/00; B66C 13/20

(52) U.S. Cl. 212/225; 212/270

(57) ABSTRACT

A method for moving a weight using a conveyor device unseats an air admittance valve of a manual valve, loads compressed air into a cylinder, moves the cylinder along with a beam and a plurality of movable pulleys, to locate the cylinder on the top of the weight. The method further moves the cylinder and a hanging ring down to connect the hanging ring and the weight, moves the cylinder along with the beam and the plurality of movable pulleys, to locate the weight on the top of an electronic scale, and moves the cylinder and the hanging ring down to place the weight on the electronic scale.

### BACKGROUND

1. Technical Field

Embodiments of the present disclosure relate to mechanical devices, and particularly to a conveyor device and method for moving a weight using the conveyor device.

2. Description of Related Art

Currently, accuracy of electronic scale devices have been tested manually using a plurality of reference weights. In this manual method, a user has to manually move the reference weights onto the electronic scale device one by one to obtain test results. However, it is a hard job for the user if a lot of weights need to be moved, especially since the weights can be heavy.

What is needed, therefore, is an improved device and method for moving weights easily.

### BRIEF DESCRIPTION OF THE DRAWINGS

FIG. 1 is one view of one embodiment of a conveyor device.

FIG. 2 is a another view of one embodiment from a different angle of the conveyor device shown in FIG. 1.

FIG. 3 is a schematic view of one embodiment of a control unit of the conveyor device shown in FIG. 1.

FIG. 4 is a plane view of one embodiment of the control unit of the conveyor device shown in FIG. 1.

FIG. 5 is a flowchart of one embodiment of a method for moving a weight using the conveyor device shown in FIG. 1.

### DETAILED DESCRIPTION

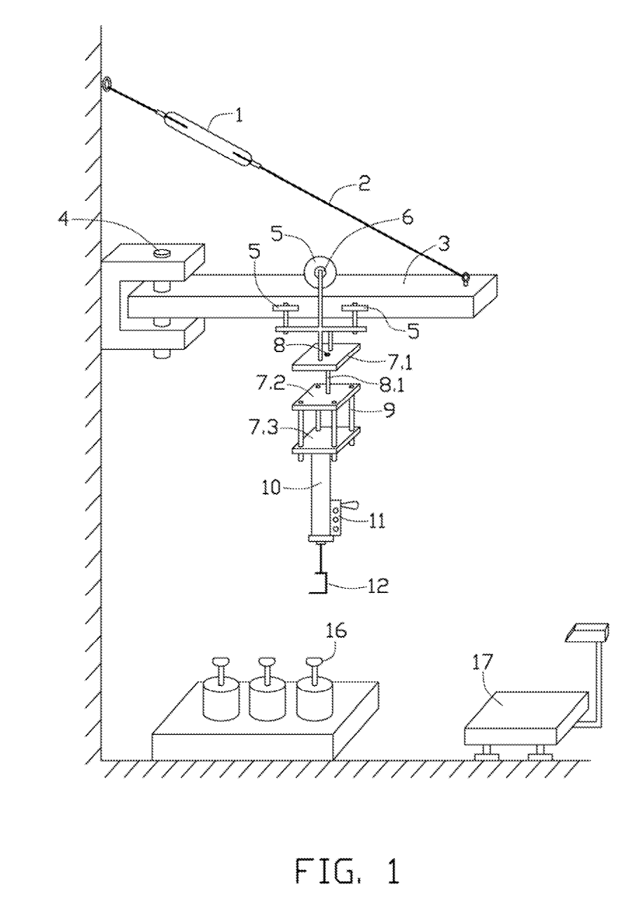

FIG. 1 is one view of one embodiment of a conveyor device. In one embodiment, the conveyor device includes a cantilever unit, a connection unit, a load-handling unit, and a control unit. Detailed descriptions will be provided below.

In one embodiment, the cantilever unit includes a turnbuckle 1, a cable 2, a beam 3, and a hinge 4. One end of the beam 3 is installed on a wall through the hinge 4, and the other end of the beam 3 is connected to the cable 2. One end of the turnbuckle 1 is installed on the wall positioned over the hinge 4, and the other end of the turnbuckle 1 is connected to the beam 3 through the cable 2 to keep the beam 3 horizontal. In one embodiment, the beam 3 is a rectangle-shaped beam, a distance between the beam 3 and the ground is two meters, and the beam 3 may rotate from about zero degrees to about 180 degrees horizontally. In another embodiment, the turnbuckle 1 and the beam 3 are installed on an upright post, so that the beam 3 may rotate from about zero degrees to about 360 degrees horizontally.

In one embodiment, the connection unit includes a plurality of movable pulleys 5, an attachment bracket 6, a first junction panel 7.1, a second junction panel 7.2, a third junction panel 7.3, a thrust ball bearing 8, a screw rod 8.1, and a plurality of long screw rods 9. Detailed descriptions will be provided below.

In one embodiment, the beam 3 is locked by the plurality of movable pulleys 5 and the attachment bracket 6, the number of the plurality of movable pulleys 5 is four. For example, the first movable pulley is installed on the top of the beam 3. The second movable pulley and the third movable pulley are located on one side (e.g., left side) of the first movable pulley, and installed on an anterior lateral wall and a posterior lateral wall of the beam 3 respectively. The fourth movable pulley is located on the other side (e.g., right side) of the first movable pulley, and installed on the anterior lateral wall or the posterior lateral wall of the beam 3. In another embodiment, the number of the plurality of movable pulleys 5 is five. Based on the five movable pulleys 5, the fourth movable pulley and the fifth movable pulley are located on the other side of the first movable pulley, and installed on the anterior lateral wall and the posterior lateral wall of the beam 3.

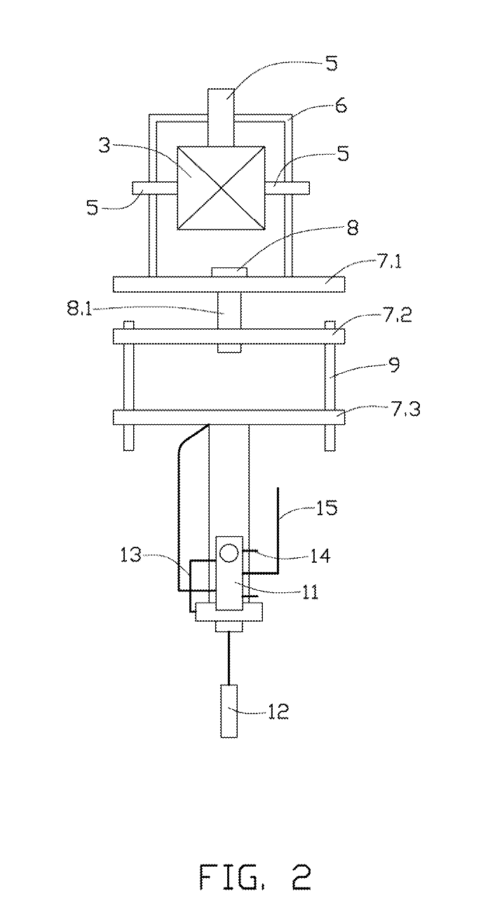

Referring to FIG. 1 and FIG. 2, the plurality of movable pulleys 5 are connected to the first junction panel 7.1 through the attachment bracket 6. In one embodiment, a center of the first junction panel 7.1 is connected to a center of the second junction panel 7.2 through the thrust ball bearing 8 and the screw rod 8.1. Also, the thrust ball bearing 8 is connected to the screw rod 8.1.

The third junction panel 7.3 is connected to the second junction panel 7.2 through the plurality of long screw rods 9. In one embodiment, a distance between the second junction panel 7.2 and the third junction panel 7.3 is adjusted by adjusting an installation position of the third junction panel 7.3 on the plurality of long screw rods 9. In one embodiment, the number of the plurality of long screw rods 9 is four.

The load-handling unit includes a cylinder (e.g., DNC SERIES 50X80) 10 and a hanging ring 12. One end of the cylinder 10 is connected to the third junction panel 7.3 through screws, and the other end of the cylinder 10 is connected to the hanging ring 12 through screws. In another embodiment, the third junction panel 7.3 may be removed, so that the cylinder 10 may connect to the second junction panel 7.2 directly through the screws.

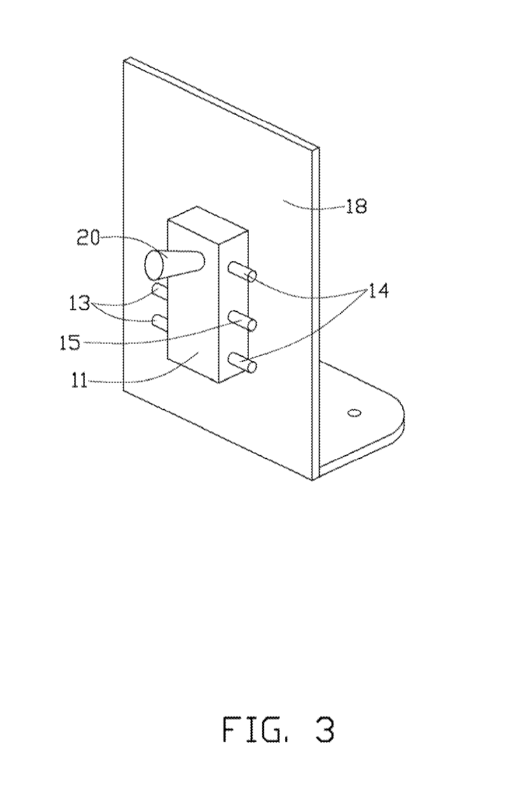

Referring to FIG. 3, the control unit includes a manual valve (e.g., AirTAC/4H210-06) 11. In one embodiment, two flow control valves 13, two damper valves 14, an air admittance valve 15, and a control handle 20 are installed on the manual valve 11. The manual valve 11 is connected to the bottom of the cylinder 10 through an L-shape metal panel 18. In one embodiment, the manual valve 11 is installed on a lateral wall of the L-shape metal panel 18, and four screw holes are located on the bottom of the L-shape metal panel 18, so that the L-shape metal panel 18 may connect to the bottom of the cylinder 10 through screws using the four screw holes.

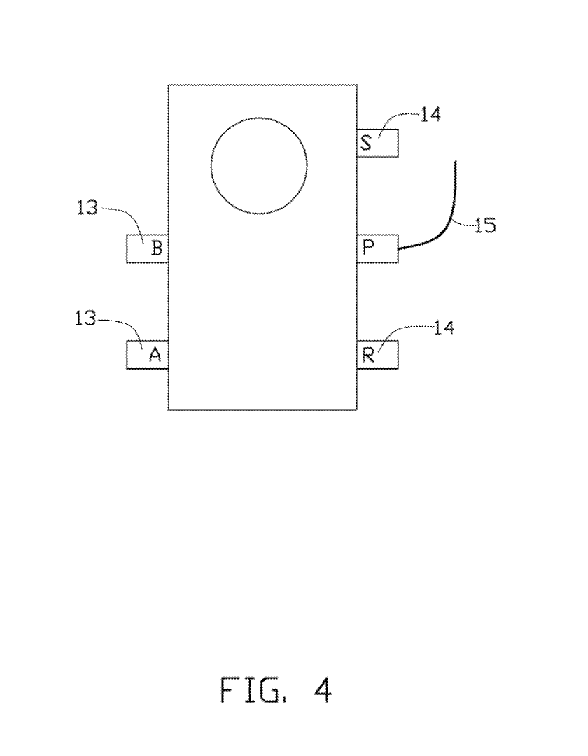

Referring to FIG. 3 and FIG. 4, the two flow control valves 13 (e.g., a flow control valve A and a flow control valve B as shown in FIG. 4) are installed on one side of the manual valve 11, and the two flow control valves 13 are connected to a upward port and a downward port of the cylinder 10. For example, the flow control valve “A” is connected to the upward port of the cylinder 10, and the flow control valve “B” is connected to the downward port of the cylinder 10.

In one embodiment, the two damper valves 14 (e.g., a damper valve R and a damper valve S as shown in FIG. 4) and the air admittance valve 15 (e.g., an air admittance valve P) are installed on the other side of the manual valve 11. The air admittance valve 15 is located between the two damper valves 14. The two damper valves 14 are two air outlet valves of the manual valve 11, and the air admittance valve 15 is used to load compressed air into the cylinder 10. A movement speed of the cylinder 10 may be adjusted by adjusting the two flow control valves 13 and the two damper valves 14. In one embodiment, the control handle 20 is used as a gear selector, and includes an up gear, a middle gear, and a down gear. If the control handle 20 is located in the up gear, the cylinder 10 may move upward. If the control handle 20 is located in the middle gear, the cylinder 10 may stop moving. If the control handle 20 is located in the down gear, the cylinder 10 may move downward.

In one embodiment, the two damper valves 14 are used to reduce noises generated by the cylinder 10 when the cylinder 10 is moving, and adjust the movement speed of the cylinder 10 if the cylinder 10 moves downward bearing a weight 16. In another embodiment, the two damper valves 14 may be replaced with the two flow control valves 13 if lower noise is generated by the cylinder.

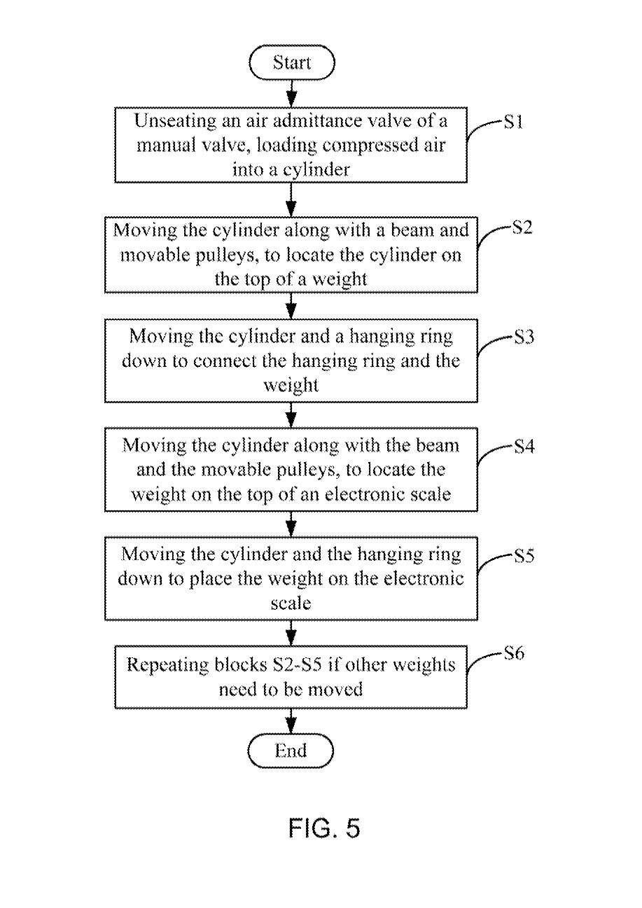

FIG. 5 is a flowchart of one embodiment of a method for moving a weight using the conveyor device. Depending on the embodiment, additional steps may be added, others removed, and the ordering of the steps may be changed.

In step S1, the air admittance valve 15 of the manual valve 11 is unseated, to load compressed air (e.g., 0.5 MPa) into the cylinder 10. Proper installation of the conveyor device is checked by a user. For example, the user determines if the cylinder 10 moves with a uniform speed, if the cylinder 10 is fixed firmly, and if the beam 3 is fixed horizontally.

In step S2, the user moves the cylinder 10 along with the beam 3 and the plurality of movable pulleys 5, to locate the cylinder 10 on the top of the weight 16.

In step S3, the user locates the control handle 20 of the cylinder 10 in the down gear, to move the cylinder 10 and the hanging ring 12 down until the hanging ring 12 is connected to the weight 16. Then, the user locates the control handle 20 of the cylinder 10 in the middle gear, to stop the movement of the cylinder 10.

In step S4, the user locates the control handle 20 of the cylinder 10 in the up gear, to move the weight 16 up. At the same time, the user moves the cylinder 10 along with the beam 3 and the plurality of movable pulleys 5, to locate the weight 16 on the top of an electronic scale 17. Then, the user locates the control handle 20 of the cylinder 10 in the middle gear, to stop the movement of the cylinder 10.

In step S5, the user locates the control handle 20 of the cylinder 10 in the down gear, to move the cylinder 10 and the hanging ring 12 downward until the weight 16 is placed on the electronic scale 17. Then, the user locates the control handle 20 of the cylinder 10 in the middle gear, to stop the movement of the cylinder 10.

In step S6, the user moves the cylinder 10 along with the beam 3 and the plurality of movable pulleys 5 to locate the cylinder 10 on the top of a next weight if other weights need to be moved, and repeats steps S2-S5.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A conveyor device, comprising:
a cantilever unit comprising a turnbuckle, a cable, a beam, and a hinge, one end of the beam being installed on an upright post through the hinge, the other end of the beam being connected to the cable, one end of the turnbuckle being installed on the upright post and positioned over the hinge, and the other end of the turnbuckle being connected to the beam through the cable to keep the beam horizontal;
a connection unit comprising a plurality of movable pulleys, an attachment bracket, a first junction panel, a second junction panel, a thrust ball bearing, and a screw rod, the beam being locked by the plurality of movable pulleys and the attachment bracket, the plurality of movable pulleys being connected to the first junction panel through the attachment bracket, and a center of the first junction panel being connected to a center of the second junction panel through the thrust ball bearing and the screw rod;
a load-handling unit comprising a cylinder and a hanging ring, one end of the cylinder being connected to the second junction panel through screws, and the other end of the cylinder being connected to the hanging ring through screws; and
a control unit comprising a manual valve, two flow control valves, two damper valves, an air admittance valve, and a control handle being installed on the manual valve, and the manual valve being connected to the bottom of the cylinder through an L-shape metal panel.

2. The conveyor device according to claim 1, wherein the beam is a rectangle-shaped beam.

3. The conveyor device according to claim 1, wherein the number of the plurality of movable pulleys is four:
the first movable pulley being installed on the top of the beam;
the second movable pulley and the third movable pulley being located on one side of the first movable pulley, and installed on an anterior lateral wall and a posterior lateral wall of the beam respectively; and
the fourth movable pulley being located on the other side of the first movable pulley, and installed on the anterior lateral wall or the posterior lateral wall of the beam.

4. The conveyor device according to claim 1, wherein the number of the plurality of movable pulleys is five:
the first movable pulley being installed on the top of the beam;
the second movable pulley and the third movable pulley being located on one side of the first movable pulley, and installed on an anterior lateral wall and a posterior lateral wall of the beam respectively; and
the fourth movable pulley and a fifth movable pulley being located on the other side of the first movable pulley, and installed on the anterior lateral wall and the posterior lateral wall of the beam respectively.

5. The conveyor device according to claim 1, wherein the manual valve is installed on a lateral wall of the L-shape metal panel, and four screw holes are located on the bottom of the L-shape metal panel, the L-shape metal panel being connected to the bottom of the cylinder through screws using the four screw holes.

6. The conveyor device according to claim 5, wherein:
the two flow control valves are installed on one side of the manual valve, and the two flow control valves are connected to a upward port and a downward port of the cylinder; and
the two damper valves and the air admittance valve are installed on the other side of the manual valve, and the two damper valves are two air outlet valves of the manual valve and the air admittance valve is used to load compressed air into the cylinder.

7. The conveyor device according to claim 5, wherein the two damper valves are replaced with the two flow control valves.

8. The conveyor device according to claim 1, further comprising a third junction panel:
the third junction panel being connected to the second junction panel through a plurality of long screw rods, and a distance between the second junction panel and the third junction panel being adjusted by adjusting an installation position of the third junction panel on the plurality of long screw rods; and
the third junction panel being connected to the cylinder through the screws.

9. A method for moving a weight using the conveyor device according to claim 1, comprising:
(a) unseating the air admittance valve of the manual valve, and loading compressed air into the cylinder;
(b) moving the cylinder along with the beam and the plurality of movable pulleys, to locate the cylinder on the top of the weight;
(c) moving the cylinder and the hanging ring down to connect the hanging ring and the weight;
(d) moving the cylinder along with the beam and the plurality of movable pulleys, to locate the weight on the top of an electronic scale; and
(e) moving the cylinder and the hanging ring down to place the weight on the electronic scale.

10. The method according to claim 9, further comprising:
moving the cylinder along with the beam and the plurality of movable pulleys to locate the cylinder on the top of a next weight if other weights need to be moved; and
repeating from block (c) to block (e).

11. The method according to claim 9, wherein the block (a) further comprises:
determining if the cylinder moves with a uniform speed;
determining if the cylinder is fixed firmly; and
determining if the beam is fixed horizontally.
